(19) United States
(12) Patent Application Publication
(10) Pub. No.: US 2023/0298340 A1
(43) Pub. Date: Sep. 21, 2023

(54) INFORMATION PROCESSING APPARATUS, MOBILE OBJECT, CONTROL METHOD THEREOF, AND STORAGE MEDIUM

(71) Applicant: HONDA MOTOR CO., LTD., Tokyo (JP)

(72) Inventor: Naoki HOSOMI, Wako-shi (JP)

(21) Appl. No.: 18/101,784

(22) Filed: Jan. 26, 2023

(30) Foreign Application Priority Data
Mar. 16, 2022 (JP) 2022-041683

(51) Int. Cl. G06V 10/98; G06V 20/58; G06V 10/776; G06V 10/77

(52) U.S. Cl. CPC G06V 10/987; G06V 10/7715; G06V 10/776; G06V 20/58; G06V 2201/07

(57) ABSTRACT

An information processing apparatus of the present invention comprises acquires a captured image; detects a plurality of targets included in the captured image, and extracts a plurality of features for each of the detected plurality of targets; acquires an impurity for each extracted feature, the impurity indicating a degree to which a predetermined target is inseparable from among the plurality of targets in a case where a user is asked a question for presuming the predetermined target from among the plurality of targets based on each feature; and generates the question to reduce a number of questions for minimizing the impurity based on the extracted features and the impurity for each of the features.

### CROSS-REFERENCE TO RELATED APPLICATION(S)

This application claims priority to and the benefit of Japanese Patent Application No. 2022-041683 filed on Mar. 16, 2022, the entire disclosure of which is incorporated herein by reference.

### BACKGROUND OF THE INVENTION

### Field of the Invention

The present invention relates to an information processing apparatus, a mobile object, a control method thereof, and a storage medium.

### Description of the Related Art

In recent years, compact mobile objects are known such as electric vehicles called ultra-compact mobility vehicles (also referred to as micro mobility vehicles) having a riding capacity of about one or two persons, and mobile interactive robots that provide various types of services to humans. These mobile objects provide various types of services by identifying whether any object among a group of targets including persons and buildings is a target object (hereinafter referred to as a final target). In order to identify a user who is a target object, the mobile object interacts with the user to narrow down the candidates.

Regarding questions to a user, Japanese Patent Laid-Open No. 2018-5624 proposes a technique of generating a question order decision tree, with which when asking a user a plurality of questions through interaction and narrowing down the candidates for classification results from the user’s answer, it is possible to reduce the number of questions to the user even in cases where the user’s answer is wrong.

### SUMMARY OF THE INVENTION

However, this conventional technique has the following problems. The conventional technique reduces the number of questions to the user while considering the possibility that the user’s answer may be wrong when narrowing down the candidates for classification results or search results. However, the conventional technique is designed to narrow down the candidates for classification results from the answers to a plurality of questions to the user, not to effectively use information other than the user answers. Especially when a user as a final target is presumed from among a plurality of persons, features in a captured image of the user’s surroundings are very significant information.

The present invention has been made in view of the above problems, and an object thereof is to generate an efficient question using features obtained through image recognition to presume a final target.

According to one aspect of the present invention, there is provided an information processing apparatus comprising: an image acquisition unit configured to acquire a captured image; an extraction unit configured to detect a plurality of targets included in the captured image, and extract a plurality of features for each of the detected plurality of targets; an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and a generation unit configured to generate the question to reduce a number of questions for minimizing the impurity based on the features extracted by the extraction unit and the impurity for each of the features.

According to another aspect of the present invention, there is provided a mobile object comprising: an image acquisition unit configured to acquire a captured image; an extraction unit configured to detect a plurality of targets included in the captured image, and extract a plurality of features for each of the detected plurality of targets; an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and a generation unit configured to generate the question to reduce a number of questions for minimizing the impurity based on the features extracted by the extraction unit and the impurity for each of the features.

According to yet another aspect of the present invention, there is provided a control method of an information processing apparatus, the control method comprising: an image acquisition step of acquiring a captured image; an extraction step of detecting a plurality of targets included in the captured image, and extracting a plurality of features for each of the detected plurality of targets; an impurity acquisition step of acquiring an impurity for each feature extracted in the extraction step, the impurity indicating a degree to which a predetermined target is inseparable from among the plurality of targets in a case where a user is asked a question for presuming the predetermined target from among the plurality of targets based on each feature; and a generation step of generating the question to reduce a number of questions for minimizing the impurity based on the features extracted by the extraction unit and the impurity for each of the features.

According to still yet another aspect of the present invention, there is provided a control method of a mobile object, the control method comprising: an image acquisition step of acquiring a captured image; an extraction step of detecting a plurality of targets included in the captured image, and extracting a plurality of features for each of the detected plurality of targets; an impurity acquisition step of acquiring an impurity for each feature extracted by the extraction unit, the impurity indicating a degree to which a predetermined target is inseparable from among the plurality of targets in a case where a user is asked a question for presuming the predetermined target from among the plurality of targets based on each feature; and a generation step of generating the question to reduce a number of questions for minimizing the impurity based on the features extracted by the extraction unit and the impurity for each of the features.

According to yet still another aspect of the present invention, there is provided a non-transitory storage medium storing a program for causing a computer to function as: an image acquisition unit configured to acquire a captured image; an extraction unit configured to detect a plurality of targets included in the captured image, and extract a plurality of features for each of the detected plurality of targets; an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and a generation unit configured to generate the question to reduce a number of questions for minimizing the impurity based on the features extracted by the extraction unit and the impurity for each of the features.

According to still yet another aspect of the present invention, there is provided a non-transitory storage medium storing a program for causing a computer to function as: an image acquisition unit configured to acquire a captured image; an extraction unit configured to detect a plurality of targets included in the captured image, and extract a plurality of features for each of the detected plurality of targets; an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and a generation unit configured to generate the question to reduce a number of questions for minimizing the impurity based on the features extracted by the extraction unit and the impurity for each of the features.

Further features of the present invention will become apparent from the following description of exemplary embodiments (with reference to the attached drawings).

### BRIEF DESCRIPTION OF THE DRAWINGS

FIG. 1 is a diagram illustrating an example of a system according to an embodiment of the present invention;

FIGS. 2A and 2B are block diagrams illustrating a hardware configuration example of a mobile object according to the present embodiment;

FIG. 3 is a block diagram illustrating a functional configuration example of the mobile object according to the present embodiment;

FIG. 4 is a block diagram illustrating configuration examples of a server and a communication device according to the present embodiment;

FIG. 5 is a diagram for explaining image acquisition according to the present embodiment;

FIG. 6 is a diagram for explaining image analysis according to the present embodiment;

FIG. 7 is a diagram for explaining question generation according to the present embodiment;

FIG. 8 is a diagram for comparing a question according to the present embodiment with questions according to a comparative example;

FIG. 9 is a flowchart illustrating a series of operations of user presumption processing using an utterance and an image according to the present embodiment;

FIG. 10 is a flowchart illustrating a series of operations of user presumption processing (S106) using an utterance and a captured image according to the present embodiment;

FIG. 11 is a flowchart illustrating a series of operations of the specific processing in S206 according to the present embodiment; and

FIG. 12 is a diagram illustrating an example of a system according to another embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### System Configuration

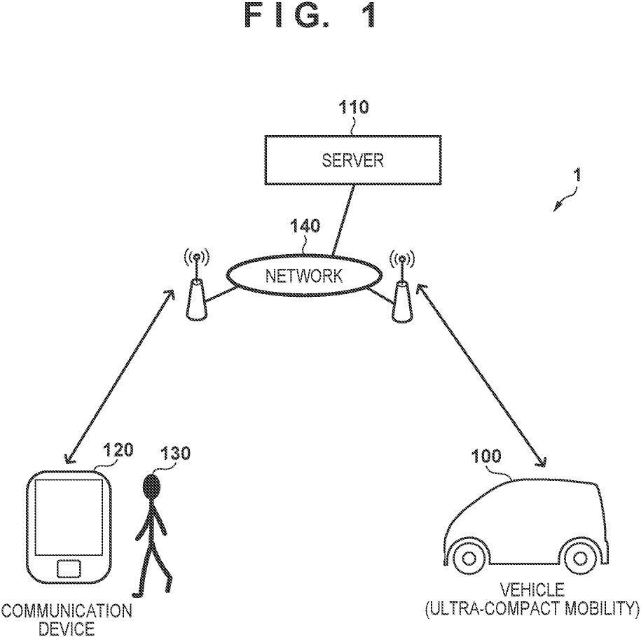

A configuration of a system 1 according to the present embodiment will be described with reference to FIG. 1. The system 1 includes a vehicle (mobile object) 100, a server 110, and a communication device (communication terminal) 120. In the present embodiment, the server 110 presumes a user by using utterance information of a user 130 and a captured image around the vehicle 100, and allows the user 130 to join the vehicle 100. The user communicates with the server 110 via a predetermined application started on the held communication device 120, and moves to a joining position (for example, a red post serving as a nearby mark) designated by the user while providing the user’s own position and the like by utterance. The server 110 controls the vehicle 100 to move to the presumed joining position, while presuming the user and the joining position. Each configuration will be described in detail below.

The vehicle 100 is equipped with a battery, and is, for example, an ultra-compact mobility vehicle that moves mainly by the power of a motor. The ultra-compact mobility vehicle is an ultra-compact vehicle that is more compact than a general automobile and has a riding capacity of about one or two persons. In the present embodiment, an example in which the vehicle 100 is the ultra-compact mobility vehicle will be described, but there is no intention to limit the present invention, and for example, a four-wheeled vehicle or a straddle type vehicle may be used. Further, the vehicle of the present invention is not limited to a vehicle that carries a person, and may be a vehicle loaded with luggage and traveling in parallel with walking of a person, or a vehicle leading a person. Furthermore, the present invention is not limited to a four-wheeled or two-wheeled vehicle, and a walking type robot or the like capable of autonomous movement can also be applied. That is, the present invention can be applied to mobile objects such as these vehicles and walking type robots, and the vehicle 100 is an example of the mobile object.

The vehicle 100 is connected to a network 140 via wireless communication such as Wi-Fi or 5th generation mobile communication. The vehicle 100 can measure states inside and outside the vehicle (a vehicle position, a traveling state, a target of a surrounding object, and the like) by various sensors and transmit measured data to the server 110. The data collected and transmitted as described above is also generally referred to as floating data, probe data, traffic information, or the like. The information on the vehicle is transmitted to the server 110 at regular intervals or in response to an occurrence of a specific event. The vehicle 100 can travel by automated driving even when the user 130 is not in the vehicle. The vehicle 100 receives information such as a control command provided from the server 110 or uses data measured by the self-vehicle to control the operation of the vehicle.

The server 110 is an example of an information processing apparatus, and includes one or more server devices and is capable of acquiring information on the vehicle transmitted from the vehicle 100 and utterance information and position information transmitted from the communication device 120 via the network 140, presuming the user 130, and controlling traveling of the vehicle 100. The traveling control of the vehicle 100 includes adjustment processing of a joining position of the user 130 and the vehicle 100.

The communication device 120 is, for example, a smartphone, but is not limited thereto, and may be an earphone type communication terminal, a personal computer, a tablet terminal, a game machine, or the like. The communication device 120 is connected to the network 140 via wireless communication such as Wi-Fi or 5th generation mobile communication.

The network 140 includes, for example, a communication network such as the Internet or a mobile phone network, and transmits information between the server 110 and the vehicle 100 or the communication device 120. In the system 1, in a case where the user 130 and the vehicle 100 at distant places approach each other to the extent that a target or the like (serving as a visual mark) can be visually confirmed, the joining position is adjusted by presuming the user using the utterance information and the image information captured by the vehicle 100. Note that, in the present embodiment, an example in which a camera that captures an image of the surroundings of the vehicle 100 is provided in the vehicle 100 will be described, but it is not always necessary to provide the camera or the like in the vehicle 100. For example, an image captured using a monitoring camera or the like already installed around the vehicle 100 may be used, or both cases may be used. As a result, when the position of the user is specified, an image captured at a more optimum angle can be used. For example, when the user utters what positional relation the user is in with respect to one mark, by analyzing an image captured by a camera close to the position predicted as the mark, it is possible to more accurately specify the user who requests joining with the ultra-compact mobility vehicle.

Before the user 130 and the vehicle 100 come close to the extent that a target or the like can be visually confirmed, first, the server 110 moves the vehicle 100 to a rough area including the current position of the user or the predicted position of the user. Then, when the vehicle 100 reaches the rough area, the server 110 transmits, to the communication device 120, voice information (for example, “Is there a store nearby?” or “Is the color of your clothes black?”) asking about information related to the visual mark or the user based on a captured image predicted to contain the user 130. The place related to the visual mark includes, for example, a name of the place included in the map information. Here, the visual mark indicates a physical object that can be visually recognized by the user, and includes, for example, various objects such as a building, a traffic light, a river, a mountain, a bronze statue, and a signboard. The server 110 receives, from the communication device 120, utterance information (for example, “There is a building of xx coffee shop”) by the user including the place related to the visual mark. Then, the server 110 acquires a position of the corresponding place from the map information, and moves the vehicle 100 to the vicinity of the place (that is, the vehicle and the user come close to the extent that the target or the like can be visually confirmed). Thereafter, according to the present embodiment, an efficient question for reducing the number of questions is generated based on features predicted by an image recognition model from a captured image of the user’s surroundings, and the user is presumed from the user’ answer to the question. The question generation method will be described in detail later. Note that the present embodiment describes the case of presuming a person who is a user, but other types of targets may be presumed instead of a person. For example, a signboard, a building, or the like designated by the user as a mark may be presumed. In this case, questions are targeted for these other types of targets.

### Configuration of Mobile Object

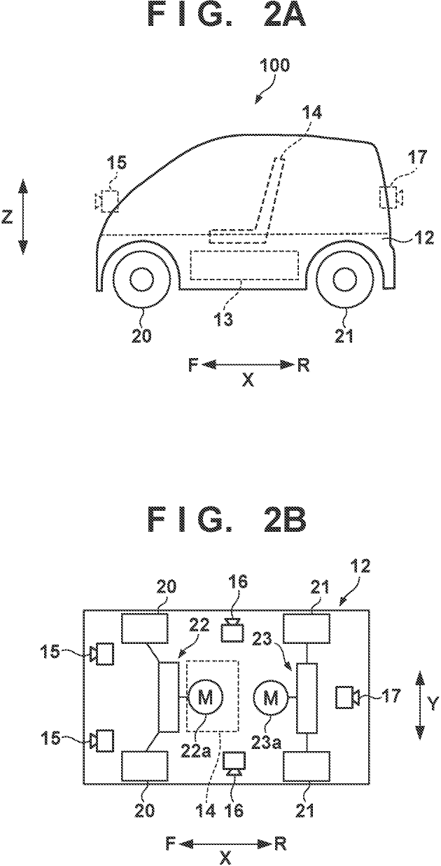

Next, a configuration of the vehicle 100 as an example of the mobile object according to the present embodiment will be described with reference to FIGS. 2A and 2B. FIG. 2A illustrates a side surface of the vehicle 100 according to the present embodiment, and FIG. 2B illustrates an internal configuration of the vehicle 100. In the drawings, an arrow X indicates a longitudinal direction of the vehicle 100, F indicates the front, and R indicates the rear. Arrows Y and Z indicate a width direction (lateral direction) and a vertical direction of the vehicle 100, respectively.

The vehicle 100 is an electric autonomous vehicle including a traveling unit 12 and using a battery 13 as a main power supply. The battery 13 is, for example, a secondary battery such as a lithium ion battery, and the vehicle 100 autonomously travels by the traveling unit 12 by electric power supplied from the battery 13. The traveling unit 12 is a four-wheeled vehicle including a pair of left and right front wheels 20 and a pair of left and right rear wheels 21. The traveling unit 12 may be in another form such as a form of a three-wheeled vehicle. The vehicle 100 includes a seat 14 for one person or two persons.

The traveling unit 12 includes a steering mechanism 22. The steering mechanism 22 is a mechanism that changes a steering angle of the pair of front wheels 20 using a motor 22a as a driving source. The traveling direction of the vehicle 100 can be changed by changing the steering angle of the pair of front wheels 20. The traveling unit 12 further includes a driving mechanism 23. The driving mechanism 23 is a mechanism that rotates the pair of rear wheels 21 using a motor 23a as a driving source. The vehicle 100 can be moved forward or backward by rotating the pair of rear wheels 21.

The vehicle 100 includes detection units 15 to 17 that detect targets around the vehicle 100. The detection units 15 to 17 are a group of external sensors that monitors the surroundings of the vehicle 100, and in the case of the present embodiment, each of the detection units 15 to 17 is an imaging device that captures an image of the surroundings of the vehicle 100 and includes, for example, an optical system such as a lens and an image sensor. However, instead of or in addition to the imaging device, a radar or a light detection and ranging (LiDAR) can be adopted.

The two detection units 15 are disposed on front portions of the vehicle 100 in a state of being separated from each other in a Y direction, and mainly detect targets in front of the vehicle 100. The detection units 16 are disposed on a left side portion and a right side portion of the vehicle 100, respectively, and mainly detect targets on sides of the vehicle 100. The detection unit 17 is disposed on a rear portion of the vehicle 100, and mainly detects targets behind the vehicle 100.

### Control Configuration of Mobile Object

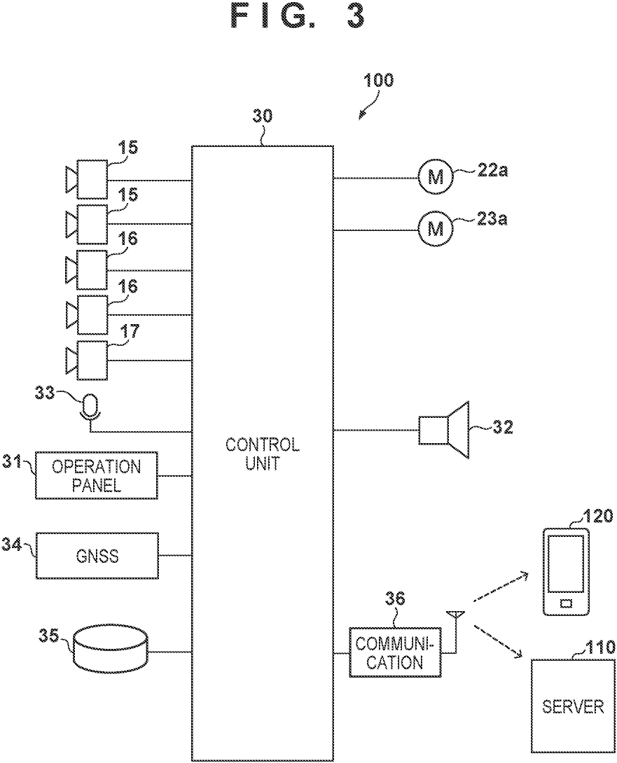

FIG. 3 is a block diagram of a control system of the vehicle 100 that is the mobile object. Here, a configuration necessary for carrying out the present invention will be mainly described. Therefore, other configurations may be further included in addition to the configuration described below. The vehicle 100 includes a control unit (ECU) 30. The control unit 30 includes a processor represented by a central processing unit (CPU), a storage device such as a semiconductor memory, an interface with an external device, and the like. In the storage device, programs executed by the processor, data used for processing by the processor, and the like are stored. A plurality of sets of processors, storage devices, and interfaces may be provided for each function of the vehicle 100 so as to be able to communicate with each other.

The control unit 30 acquires detection results of the detection units 15 to 17, input information of an operation panel 31, voice information input from a voice input device 33, a control command (for example, transmission of a captured image or a current position, or the like) from the server 110, and the like, and executes corresponding processing. The control unit 30 performs control of the motors 22a and 23a (traveling control of the traveling unit 12), display control of the operation panel 31, notification to an occupant of the vehicle 100 by voice, and output of information.

The voice input device 33 collects a voice of the occupant of the vehicle 100. The control unit 30 can recognize the input voice and execute corresponding processing. A global navigation satellite system (GNSS) sensor 34 receives a GNSS signal and detects a current position of the vehicle 100. A storage apparatus 35 is a mass storage device that stores map data and the like including information regarding a traveling road on which the vehicle 100 can travel, landmarks such as buildings, stores, and the like. In the storage apparatus 35, programs executed by the processor, data used for processing by the processor, and the like may be stored. The storage apparatus 35 may store various parameters (for example, learned parameters of a deep neural network, hyperparameters, and the like) of a machine learning model for voice recognition or image recognition executed by the control unit 30. A communication unit 36 is, for example, a communication device that can be connected to the network 140 via wireless communication such as Wi-Fi or 5th generation mobile communication.

### Configurations of Server and Communication Device

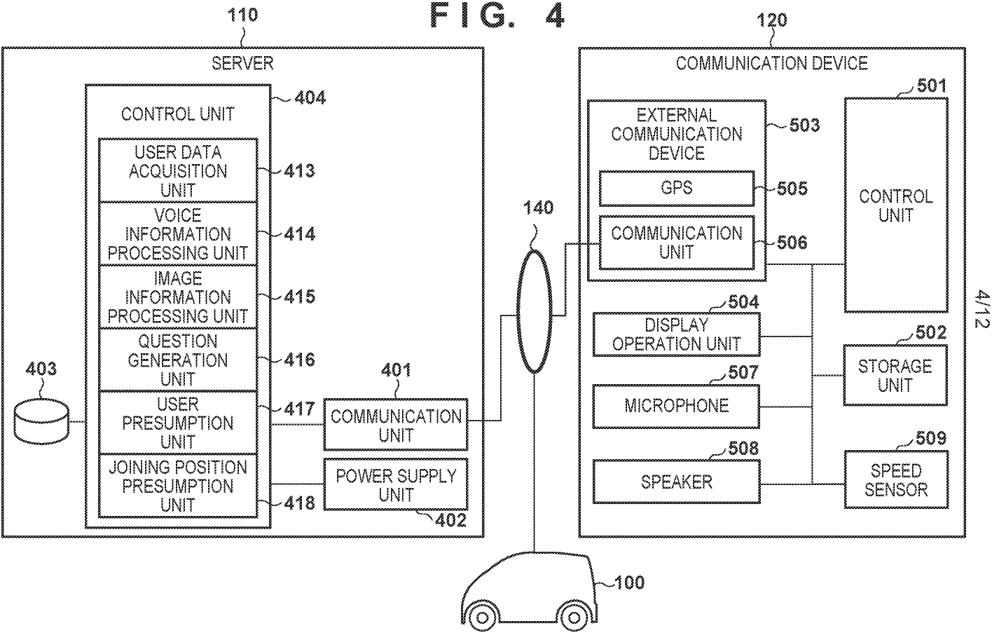

Next, configuration examples of the server 110 and the communication device 120 as an example of the information processing apparatus according to the present embodiment will be described with reference to FIG. 4. Note that the functionality of the server 110 to be described below may be realized by the vehicle 100 as will be shown in the modification section. In this case, a control unit 404 of the server 110 to be described later is integrated with the control unit 30 of the mobile object.

### (Configuration of Server)

First, a configuration example of the server 110 will be described. Here, a configuration necessary for carrying out the present invention will be mainly described. Therefore, other configurations may be further included in addition to the configuration described below. The control unit 404 includes a processor represented by a CPU, a storage device such as a semiconductor memory, an interface with an external device, and the like. In the storage device, programs executed by the processor, data used for processing by the processor, and the like are stored. A plurality of sets of processors, storage devices, and interfaces may be provided for each function of the server 110 so as to be able to communicate with each other. The control unit 404 executes various operations of the server 110, joining position adjustment processing described later, and the like by executing the program. In addition to the CPU, the control unit 404 may further include a graphical processing unit (GPU) or dedicated hardware suitable for executing processing of a machine learning model such as a neural network.

A user data acquisition unit 413 acquires information of an image and a position transmitted from the vehicle 100. Further, the user data acquisition unit 413 acquires at least one of the utterance information of the user 130 and the position information of the communication device 120 transmitted from the communication device 120. The user data acquisition unit 413 may store the acquired image and position information in a storage unit 403. The information of the image and the utterance acquired by the user data acquisition unit 413 is input to a learned model in an inference stage in order to obtain an inference result, but may be used as learning data for learning the machine learning model executed by the server 110.

A voice information processing unit 414 includes a machine learning model that processes voice information, and executes processing of a learning stage or processing of an inference stage of the machine learning model. The machine learning model of the voice information processing unit 414 performs, for example, computation of a deep learning algorithm using a deep neural network (DNN) to recognize a place name, a landmark name such as a building, a store name, a target name, and the like included in the utterance information. The target may include a pedestrian, a signboard, a sign, equipment installed outdoors such as a vending machine, building components such as a window and an entrance, a road, a vehicle, a two-wheeled vehicle, and the like included in the utterance information. The DNN becomes a learned state by performing the processing of the learning stage, and can perform recognition processing (processing of the inference stage) for new utterance information by inputting the new utterance information to the learned DNN. Note that, in the present embodiment, a case where the server 110 executes voice recognition processing will be described as an example, but the voice recognition processing may be executed in the vehicle or the communication device, and a recognition result may be transmitted to the server 110.

An image information processing unit 415 includes a machine learning model that processes image information, and executes processing of a learning stage or processing of an inference stage of the machine learning model. The machine learning model of the image information processing unit 415 performs processing of recognizing a target included in image information by performing computation of a deep learning algorithm using a deep neural network (DNN), for example. The target may include a pedestrian, a signboard, a sign, equipment installed outdoors such as a vending machine, building components such as a window and an entrance, a road, a vehicle, a two-wheeled vehicle, and the like included in the image. For example, the machine learning model of the image information processing unit 415 is an image recognition model, and extracts characteristics of a pedestrian included in the image (for example, an object near the pedestrian, the color of their clothes, the color of their bag, the presence or absence of a mask, the presence or absence of a smartphone, and the like).

A question generation unit 416 acquires an impurity for each feature based on a plurality of features extracted by the image recognition model from the captured image captured by the vehicle 100 and the reliability thereof, and recursively generates a group of questions that minimizes the impurity in the shortest time based on the derived impurity. The impurity indicates a degree to which a final target among a group of targets is inseparable (from the other targets in the group). A user presumption unit 417 presumes a user according to the user’s answer to the generated question. Here, the user presumption is to presume a user (final target) who requests to join the vehicle 100, and the user is presumed from one or more persons in a predetermined region. A joining position presumption unit 418 executes adjustment processing of the joining position of the user 130 and the vehicle 100. Details of the acquisition processing of the impurity, the presumption processing of the user, and the adjustment processing of the joining position will be described later.

Note that the server 110 can generally use more abundant calculation resources than the vehicle 100 and the like. Further, by receiving and accumulating image data captured by various vehicles, learning data in a wide variety of situations can be collected, and learning corresponding to more situations becomes possible. An image recognition model is generated from the accumulated information, and characteristics of a captured image are extracted using the image recognition model.

A communication unit 401 is, for example, a communication device including a communication circuit and the like, and communicates with an external device such as the vehicle 100 or the communication device 120. The communication unit 401 receives at least one of image information and position information from the vehicle 100, and utterance information and position information from the communication device 120, and transmits a control command to the vehicle 100 and utterance information to the communication device 120. A power supply unit 402 supplies electric power to each unit in the server 110. The storage unit 403 is a nonvolatile memory such as a hard disk or a semiconductor memory.

### (Configuration of Communication Device)

Next, a configuration of the communication device 120 will be described. The communication device 120 indicates a portable device such as a smartphone possessed by the user 130. Here, a configuration necessary for carrying out the present invention will be mainly described. Therefore, other configurations may be further included in addition to the configuration described below. The communication device 120 includes a control unit 501, a storage unit 502, an external communication device 503, a display operation unit 504, a microphone 507, a speaker 508, and a speed sensor 509. The external communication device 503 includes a GPS 505 and a communication unit 506.

The control unit 501 includes a processor represented by a CPU. The storage unit 502 stores programs executed by the processor, data used for processing by the processor, and the like. Note that the storage unit 502 may be incorporated in the control unit 501. The control unit 501 is connected to the other components 502, 503, 504, 508, and 509 by a signal line such as a bus, can transmit and receive signals, and controls the entire communication device 120.

The control unit 501 can communicate with the communication unit 401 of the server 110 via the network 140 using the communication unit 506 of the external communication device 503. Further, the control unit 501 acquires various types of information via the GPS 505. The GPS 505 acquires a current position of the communication device 120. As a result, for example, the position information can be provided to the server 110 together with the utterance information of the user. Note that the GPS 505 is not an essential component in the present invention, and the present invention provides a system that can be used even in a facility such as indoors, in which position information of the GPS 505 cannot be acquired. Therefore, the position information by the GPS 505 is treated as supplementary information for presuming the user.

The display operation unit 504 is, for example, a touch panel type liquid crystal display, and can perform various displays and receive a user operation. An inquiry content from the server 110 and information such as a joining position with the vehicle 100 are displayed on the display operation unit 504. Note that, in a case where there is an inquiry from the server 110, it is possible to cause the microphone 507 of the communication device 120 to acquire the user’s utterance by operating a microphone button displayed in a selectable manner. The microphone 507 acquires the utterance by the user as voice information. For example, the microphone may transition to a starting state by pressing the microphone button displayed on an operation screen to acquire the user’s utterance. The speaker 508 outputs a voice message at the time of making an inquiry to the user according to an instruction from the server 110 (for example, “Is the color of your bag red?” or the like). In a case of an inquiry by voice, for example, even in a simple configuration such as a headset in which the communication device 120 does not have a display screen, it is possible to communicate with the user. Further, even in a case where the user does not hold the communication device 120 in hand or the like, the user can listen to an inquiry of the server 110 from an earphone or the like, for example. In a case of an inquiry by text, the inquiry from the server 110 is displayed on the display operation unit of the communication device 120, and the user presses a button displayed on the operation screen or inputs text in a chat window so that the user’s answer can be acquired. In this case, unlike in the case of an inquiry by voice, the inquiry can be made without being affected by surrounding environmental sound (noise).

The speed sensor 509 is an acceleration sensor that detects acceleration in a longitudinal direction, a lateral direction, and a vertical direction of the communication device 120. An output value indicating the acceleration output from the speed sensor 509 is stored in a ring buffer of the storage unit 502, and is overwritten from the oldest record. The server 110 may acquire these pieces of data and use the data to detect a movement direction of the user.

### Outline of Question Generation Using Utterance and Image

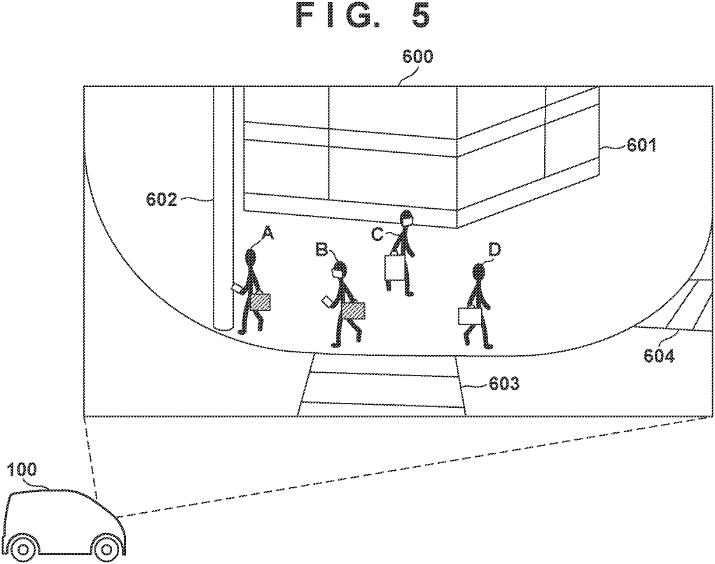

An outline of question generation using an utterance and an image executed in the server 110 will be described with reference to FIGS. 5 to 8. Here, a process of generating an efficient question for specifying a user as a final target or a target serving as a mark such as a signboard from a captured image acquired by the vehicle 100 will be described.

### (Captured Image)

FIG. 5 is a diagram illustrating an example of a captured image acquired by the vehicle 100. In FIG. 5, the vehicle 100 has moved to a rough location based on the utterance information and position information of the user. After moving to the rough location, the vehicle 100 captures an image of the surroundings of the presumed location of the user who is the final target using at least one of the detection units 15 to 17. A captured image 600 includes pedestrians A, B, C, and D, a building 601, an electric pole 602, and crosswalks 603 and 604 on the road. Upon acquiring the captured image 600, the vehicle 100 transmits the captured image 600 to the server 110. Note that, in a case where the vehicle 100 holds an image recognition model, the vehicle 100 may extract characteristics from the captured image. Further, in a case where the vehicle 100 does not have an imaging function, an image captured using a camera installed in another vehicle or a building nearby may be acquired. Further, image analysis may be performed using a plurality of such captured images.

### (Extraction of Features)

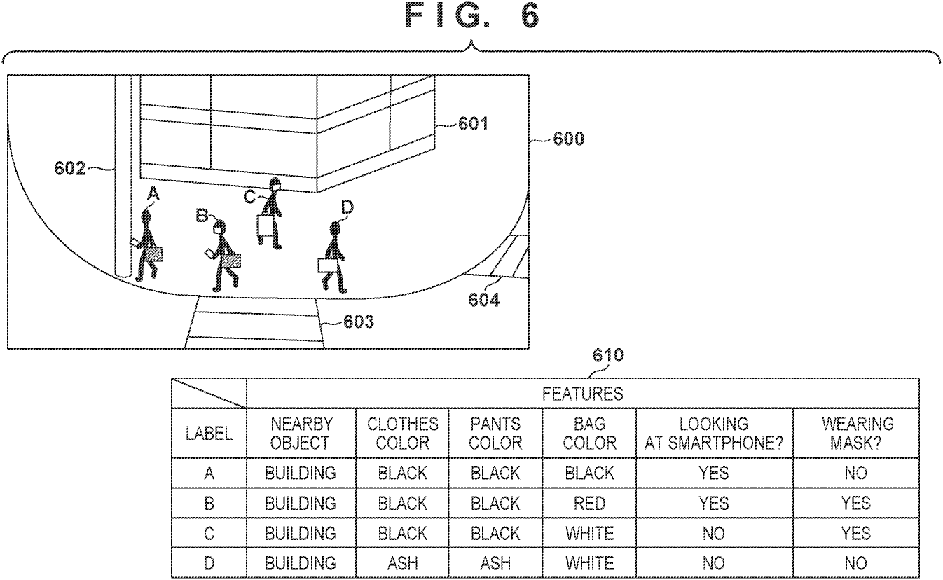

FIG. 6 is a diagram illustrating features extracted from the captured image 600 by the image recognition model in the server 110. Reference numeral 610 shows the extracted characteristics (hereinafter referred to as features). The image information processing unit 415 of the server 110 first detects a person using the image recognition model. In the captured image 600, the four pedestrians A to D are detected. Thereafter, the image information processing unit 415 extracts features for each of the detected persons. As shown in 610, examples of features that are detected in relation to a plurality of detected persons include an object located near the detected person, the color and type of the detected person’s clothes, the color of their pants, the color of their bag, and the like. Furthermore, the detected person’s behavior is also detected: e.g. whether the person is looking at their smart phone, wearing a mask, or standing, which direction the person is facing, and the like. As shown in 610, features are extracted for each of the detected pedestrians A to D. Further, in a case where a final target is a building or a signboard, detected features may include an object located near the detected target, the color and type of the detected target, a character and a pattern shown on the target, and the like.

### (Generation of Question According to Impurity)

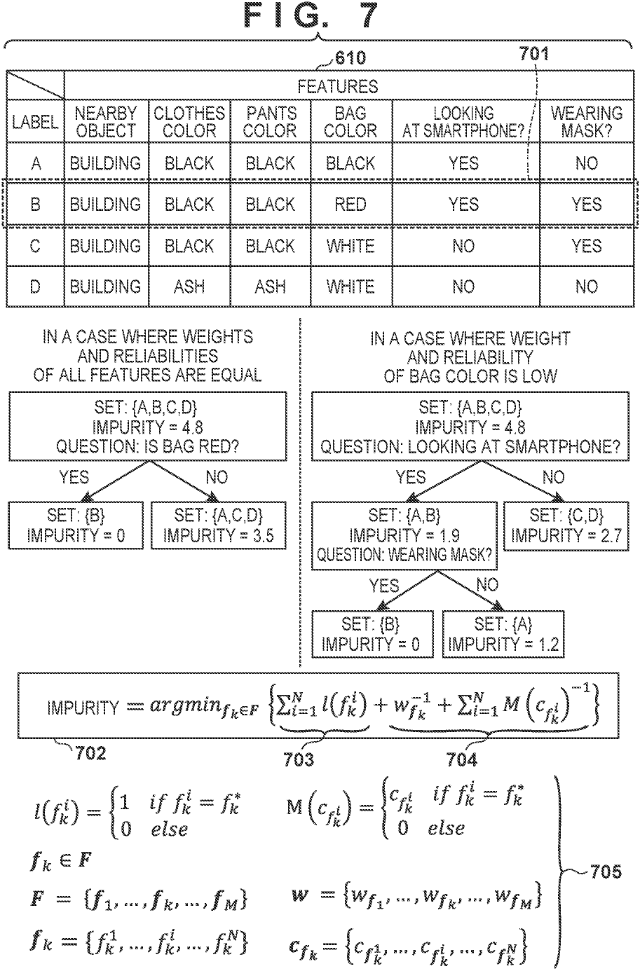

FIG. 7 is a diagram for explaining a question generation method using impurity according to the present embodiment. First, the question generation unit 416 of the server 110 extracts one or more features with the image recognition model, and further acquires a feature value, the reliability thereof, and the weight of the feature itself. The reliability is, for example, a value indicating how much the image recognition model has confidence in the prediction of the feature value. The weight is a value indicating how much the feature is reflected in the impurity calculation. The reliability and the weight may be values updated as needed by machine learning. The weight of features can also be set heuristically for each feature. Furthermore, the question generation unit 416 recursively generates an optimum and efficient question according to the acquired features and the weight and reliability thereof. Note that desirable questions to be generated are questions that a human can answer with Yes/No, and this can reduce the diversity of answers. That is, this produces a secondary effect of lowering the difficulty of utterance understanding and voice recognition by the computer.

The example case illustrated in FIG. 7 will be described. As shown in 610, features are extracted for the pedestrians A to D from the captured image 600. Among them, suppose that the target user, i.e. the user who has requested to join, is B as shown in 701. As described above, impurity indicates a degree to which a final target among a group of targets is inseparable (from the other targets in the group). Therefore, in a state where all of the pedestrians A to D are included, the impurity computation model to be described later produces an impurity of “4.8”.

Here, in a case where the weights and the reliabilities of all the features are equal, the question generation unit 416 generates a question that minimizes the impurity in the shortest time, in other words, a question for asking a characteristic unique to only one user, for example, “Is the color of your bag red?”. Of course, in a case where there is no characteristic unique to only one user, a plurality of questions may be generated. In this case, the questions may be sequentially asked, or one of the questions may be preferentially asked by taking into account a characteristic of the most likely user with reference to other information, e.g. position information of the user. In the example of 610, if the user answers “Yes” to the above question, the pedestrian B can be presumed to be the target user. On the other hand, if the user answers “No”, the set is narrowed down to the pedestrians A, C, and D, and the next question is generated.

On the other hand, in a case where the weight and reliability of bag color is low, the question generation unit 416 generates a question using another feature having a high weight and reliability, e.g. “Are you looking at the smart phone?”. If the user answers “Yes”, the set is narrowed down to the pedestrians A and B, and the impurity becomes “1.9”. Subsequently, the question generation unit 416 generates a question “Are you wearing a mask?”. As a result, the target user can be presumed regardless of whether the user answers “Yes” or “No”. In this manner, the question generation unit 416 generates an optimum and efficient question by considering the weight of features and the reliability of feature values.

The impurity computation model can be formulated in various ways. Possible examples include heuristic formulation and function approximation using a neural network or the like. As described above, the weight of features can be set heuristically or learned from data by machine learning.

The impurity computation model is exemplified by 702 of FIG. 7. Reference numeral 703 indicates the number of objects excluding the final target included in the set. For example, if the final target is a person, 703 indicates the number of persons excluding the predetermined person included in a set of persons. The smaller N, the smaller the impurity. Reference numeral 704 indicates a penalty that is based on the weight of features and the reliability of feature values. The smaller the penalty, the smaller the impurity. Reference numeral 705 indicates the content of each variable. Further, reference sign F represents a set of features (sets of feature values), and reference sign M represents the dimension number of features. Reference sign fₖ represents a set of feature values of each object for the k-th feature. Here, f*ₖ represents a feature value of the target user. Reference sign N represents the number of objects. Reference sign w represents a set of weights of features. Reference sign C_{fk} indicates the reliability obtained from the image recognition result of each object for the k-th feature. Note that the impurity computation model 702 is merely an example, and there is no intention to limit the present invention. For example, instead of simply calculating the sum of the terms 703 and 704, a coefficient may be introduced or normalization that is based on the number of objects or the like may be introduced. Further, for the penalty term, instead of simply calculating the reciprocal of the weight or reliability, another calculation or function may be introduced. Furthermore, function approximation with a neural network or the like may be introduced according to the amount of data collected.

### (Generated Efficient Question)

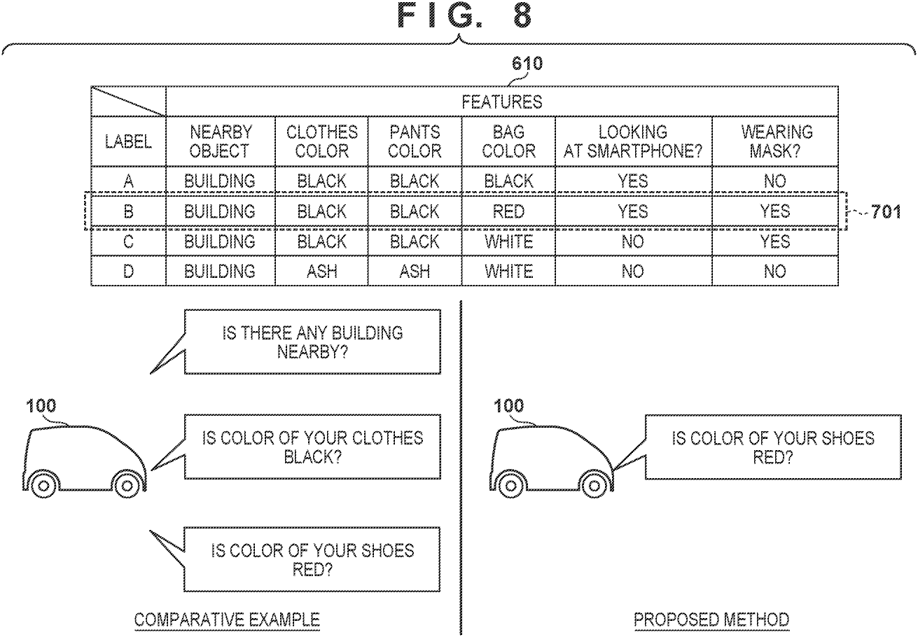

FIG. 8 shows an example of an efficient question according to the present embodiment and questions according to a comparative example. In the comparative example, questions are sequentially generated using the extracted features shown in 610 so as to narrow down the target user. Therefore, there is a high possibility that a plurality of questions may be generated, such as the questions shown in FIG. 8: “Is there any building nearby?”, which is characteristic of all the pedestrians A to D, and “Is the color of your clothes black?”, which is characteristic of the pedestrians A and B. On the other hand, according to the invention of the present application, a question “Is the color of your shoes red?” is generated using a characteristic of as few pedestrians as possible, as described above with reference to FIG. 8. For example, if the pedestrian B is the target user, the answer “Yes” is accepted, and the target user can be identified with the one question. Thus, according to the present embodiment, the impurity can be minimized in the shortest time, whereby the number of interactions for presuming the target user can be minimized.

### Series of Processing Procedures for Joining Control

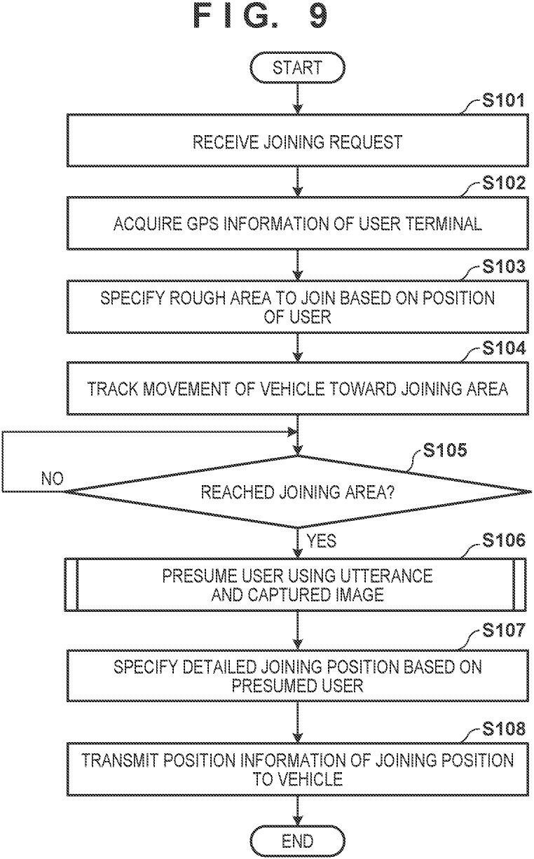

Next, a series of operations of joining control in the server 110 according to the present embodiment will be described with reference to FIG. 9. Note that the present processing is realized by the control unit 404 executing a program. Note that, in the following description, it is assumed that the control unit 404 executes each process for the sake of simplicity of description, but corresponding processing is executed by each unit of the control unit 404. Note that, here, a flow in which the user and the vehicle finally join will be described, but a characteristic configuration of the present invention is a configuration related to presumption (identification) of the user, and a configuration for presuming the joining position is not essential. That is, in the following, a processing procedure including control related to presumption of the joining position will be described, but control may be performed such that only a processing procedure related to presumption of the user is performed.

In S101, the control unit 404 receives a request (joining request) to start joining the vehicle 100 from the communication device 120. In S102, the control unit 404 acquires the position information of the user from the communication device 120. Note that the position information of the user is position information acquired by the GPS 505 of the communication device 120. Further, the position information may be received simultaneously with the request in S101. In S103, the control unit 404 specifies a rough area (it is also simply referred to as a joining area or a predetermined region) to join based on the position of the user acquired in S102. The joining area is, for example, an area where a radius centered on the current position of the user 130 (communication device 120) is a predetermined distance (for example, several hundred meters).

In S104, the control unit 404 tracks the movement of the vehicle 100 toward the joining area based on the position information periodically transmitted from the vehicle 100, for example. Note that the control unit 404 can select a vehicle closest to the current position of the user 130 as the vehicle 100 to join the user 130 from a plurality of vehicles located around the current position (or the arrival point after a predetermined time). Alternatively, in a case where the information designating the specific vehicle 100 is included in the joining request, the control unit 404 may select the specific vehicle 100 as the vehicle 100 to join the user 130.

In S105, the control unit 404 determines whether the vehicle 100 has reached the joining area. For example, when the distance between the vehicle 100 and the communication device 120 is within the radius of the joining area, the control unit 404 determines that the vehicle 100 has reached the joining area, and advances the processing to S106. If not, the server 110 returns the processing to S105 and waits for the vehicle 100 to reach the joining area.

In S106, the control unit 404 presumes the user using an utterance and a captured image. Details of the user presumption processing using the user’s utterance and captured image here will be described later. Next, in S107, the control unit 404 further presumes the joining position based on the user presumed in S106. For example, by presuming the user in the captured image, in a case where the user has uttered “nearby red post” or the like as the joining position, it is possible to presume the joining position more accurately by searching for the red post close to the presumed user. Thereafter, in S108, the control unit 404 transmits the position information of the joining position to the vehicle. That is, the control unit 404 transmits the joining position presumed in the processing of S107 to the vehicle 100 to cause the vehicle 100 to move to the joining position. After transmitting the joining position to the vehicle 100, the control unit 404 ends the series of operations.

### Series of Operations of User Presumption Processing Using Utterance and Captured Image

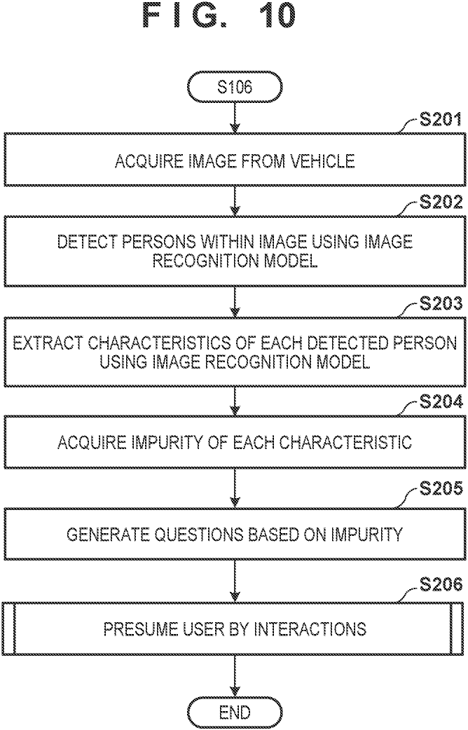

Next, a series of operations of user presumption processing (S106) using an utterance and a captured image in the server 110 will be described with reference to FIG. 10. Note that the present processing is realized by the control unit 404 executing a program, similarly to the processing illustrated in FIG. 9.

In S201, the control unit 404 acquires a captured image captured by the vehicle 100. Note that an image may be acquired from some vehicle other than the vehicle 100 or from a monitoring camera installed in a building near the expected location of the target user.

In S202, the control unit 404 detects one or more persons included in the acquired captured image using the image recognition model. Subsequently, in S203, the control unit 404 extracts characteristics of each of the detected persons using the image recognition model. As the result of the processing of S202 and S203, for example, the persons and their characteristics shown in 610 of FIG. 6 are extracted. Note that, here, each of the extracted features is assigned a weight and a reliability.

Next, in S204, the control unit 404 acquires the impurity of each characteristic extracted in S203 using the above-described computation formula. Subsequently, in S205, the control unit 404 generates a minimum number of questions based on the impurity.

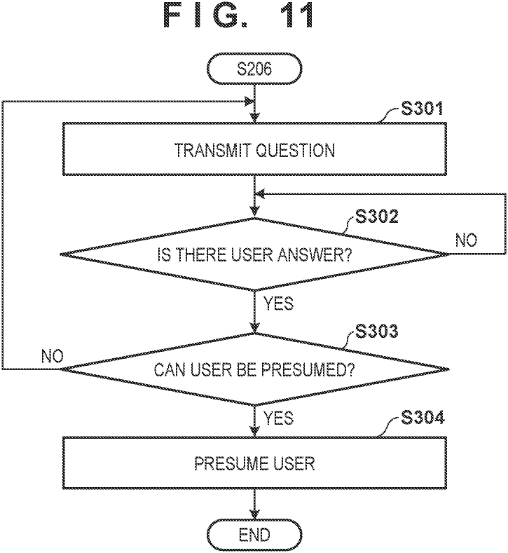

In S206, the control unit 404 transmits a question to the user according to the generated questions, presumes the user by repeatedly asking questions until the user can be presumed according to the user answer, and ends the processing of this flowchart. Detailed processing will be described later using FIG. 11.

Detailed processing of S206 will be described with reference to FIG. 11. Note that the present processing is realized by the control unit 404 executing a program, similarly to the processing illustrated in FIG. 9.

In S301, the control unit 404 transmits, to the communication device 120, a question in a group of a minimum number of questions selected from the generated group of questions based on the weight and reliability of the characteristic related to each question and the number of questions. Here, a group of questions indicates a set including one or more questions and with which it is possible to presume the target user by interacting with the user following the questions in the group.

Next, in S302, the control unit 404 determines whether a user answer to the question transmitted in S301 has been received from the communication device 120. If a user answer has been received, the processing proceeds to S303, and if not, the processing halts in S302 until a user answer is received. Note that if no user answer is received by the time a predetermined period has elapsed from the transmission of the question, the question may be transmitted again or the processing may be terminated with error.

In S303, the control unit 404 determines whether the target user can be narrowed down by the user answer. Specifically, if the user presumption is possible, the processing proceeds to S304, and if not, the processing returns to S301 to transmit the next question. In S304, the control unit 404 presumes the target user, and ends the processing of this flowchart.

### Modification

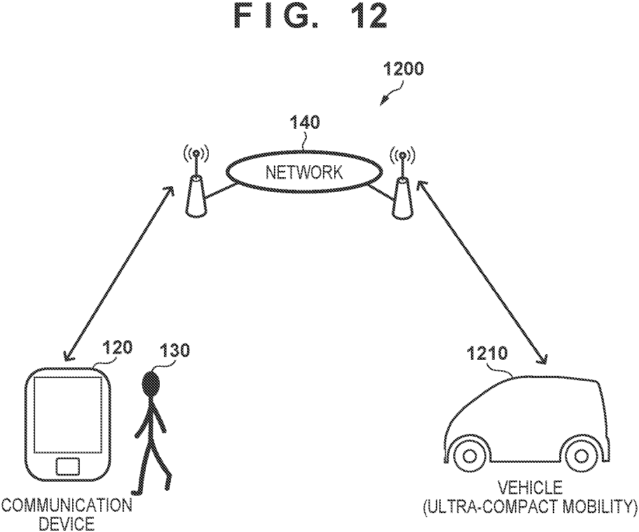

Hereinafter, a modification according to the present invention will be described. In the above embodiment, the example in which joining control including user presumption is executed in the server 110 has been described. However, the above-described processing can also be executed by a mobile object such as a vehicle or a walking type robot. In this case, as illustrated in FIG. 12, a system 1200 includes a vehicle 1210 and the communication device 120. Utterance information of the user is transmitted from the communication device 120 to the vehicle 1210. Image information captured by the vehicle 1210 is processed by a control unit in the vehicle instead of being transmitted via a network. A configuration of the vehicle 1210 may be the same as that of the vehicle 100 except that the control unit 30 can execute joining control. The control unit 30 of the vehicle 1210 operates as a control device in the vehicle 1210, and executes the above-described processing by executing the stored program. Communication between the server and the vehicle in the series of operations illustrated in FIGS. 9 to 11 is performed inside the vehicle (for example, inside the control unit 30 or between the control unit 30 and the detection unit 15). The other processing can be executed similarly to the server.

### Summary of Embodiment

1. An information processing apparatus (e.g. 110) according to the above embodiment includes:
an image acquisition unit (401) configured to acquire a captured image;
an extraction unit (415, S203) configured to detect a plurality of targets included in the captured image, and extract a plurality of features for each of the plurality of targets detected;
an impurity acquisition unit (415, S204) configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation unit (416, S205) configured to generate the question to reduce a number of questions for minimizing the impurity based on the features extracted by the extraction unit and the impurity for each of the features.

According to this embodiment, it is possible to generate an efficient question using features obtained through image recognition to presume a final target.

2. In the information processing apparatus according to the above embodiment, the extraction unit extracts the features using an image recognition model (S203), and the generation unit generates the question that minimizes the impurity in a shortest time based on a reliability and a weight of the features extracted using the image recognition model in addition to the features and the impurity (S205).

According to this embodiment, it is possible to efficiently extract features with the learned image recognition model, and to generate an optimum question according to the reliability and weight thereof.

3. In the information processing apparatus according to the above embodiment, the reliability indicates a reliability of a feature value indicating a value of a feature extracted by the image recognition model for each of the plurality of targets (FIG. 7). Further, the weight is set, for each feature, heuristically or based on machine learning (FIG. 7).

According to this embodiment, it is possible to efficiently extract features with the learned image recognition model, to generate an optimum question according to the reliability and weight thereof, and further to set the weight of each feature suitably.

4. In the information processing apparatus according to the above embodiment, the impurity is acquired according to at least one or more of a number of targets excluding the predetermined target included in a set of the plurality of targets, and a penalty that is based on the weight and/or the reliability of the feature (FIG. 7).

According to this embodiment, it is possible to derive the impurity and efficiently generate a question by considering the reliability and weight of each feature.

5. The information processing apparatus according to the above embodiment further includes: a transmission unit (401, S301) configured to transmit a question generated by the generation unit to a communication device possessed by the user; a reception unit (401, S302) configured to receive an answer to the question from the communication device; and a presumption unit (417, S304) configured to presume the predetermined target from among the plurality of targets according to the answer received by the reception unit.

According to this embodiment, it is possible to efficiently presume a target such as a user according to the question generated so as to minimize the impurity in the shortest time.

6. In the information processing apparatus according to the above embodiment, the image acquisition unit acquires position information from a communication device possessed by the user, and acquires a captured image of surroundings of the position information from outside (401, 413).

According to this embodiment, it is possible to specify a rough location of the user, and further to use a captured image of its surroundings for question generation.

7. In the information processing apparatus according to the above embodiment, the image acquisition unit acquires an image captured by a vehicle that the user requests to join from the vehicle (15 to 17, S201).

According to this embodiment, it is possible to more accurately presume a target and join the target user.

8. In the information processing apparatus according to the above embodiment, the image acquisition unit acquires a captured image captured by a camera installed around the position information from the camera.

According to this embodiment, it is possible to acquire an image of the target user’s surroundings even in a case where the vehicle does not have an imaging function.

9. In the information processing apparatus according to the above embodiment, in a case where the target is a person, the feature is at least one piece of information indicating a nearby object, clothes color, clothes type, bag color, whether the person is looking at a communication device, and whether the person is wearing a mask (FIG. 8). Further, the feature is at least one piece of information of color of the target, type of the target, a character shown on the target, and a pattern shown on the target.

According to this embodiment, it is possible to efficiently presume a target (including a user who is a target) based on various features.

10. A mobile object (e.g. 1210) according to the above embodiment includes:
an image acquisition unit (401) configured to acquire a captured image;
an extraction unit (415, S203) configured to detect a plurality of targets included in the captured image, and extract a plurality of features for each of the6 plurality of targets detected;
an impurity acquisition unit (415, S204) configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation unit (416, S205) configured to generate the question to reduce a number of questions for minimizing the impurity based on the features extracted by the extraction unit and the impurity for each of the features.

According to this embodiment, it is possible for the mobile object to generate an efficient question without intervention by a server using features obtained through image recognition to presume a target.

The invention is not limited to the foregoing embodiments, and various variations/changes are possible within the spirit of the invention.

What is claimed is:

1. An information processing apparatus comprising:
an image acquisition unit configured to acquire a captured image;
an extraction unit configured to detect a plurality of targets included in the captured image, and extract a plurality of features for each of the detected plurality of targets;
an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation unit configured to generate the question to reduce a number of questions for minimizing the impurity based on the features extracted by the extraction unit and the impurity for each of the features.

2. The information processing apparatus according to claim 1, wherein
the extraction unit extracts the features using an image recognition model, and
the generation unit generates the question that minimizes the impurity in a shortest time based on a reliability and a weight of the features extracted using the image recognition model in addition to the features and the impurity.

3. The information processing apparatus according to claim 2, wherein the reliability indicates a reliability of a feature value indicating a value of a feature extracted by the image recognition model for each of the plurality of targets.

4. The information processing apparatus according to claim 2, wherein the weight is set, for each feature, heuristically or based on machine learning.

5. The information processing apparatus according to claim 2, wherein the impurity is acquired according to at least one or more of a number of targets excluding the predetermined target included in a set of the plurality of targets, and a penalty that is based on the weight and/or the reliability of the feature.

6. The information processing apparatus according to claim 1, further comprising:
a transmission unit configured to transmit a question generated by the generation unit to a communication device possessed by the user;
a reception unit configured to receive an answer to the question from the communication device; and
a presumption unit configured to presume the predetermined target from among the plurality of targets according to the answer received by the reception unit.

7. The information processing apparatus according to claim 1, wherein the image acquisition unit acquires position information from a communication device possessed by the user, and acquires a captured image of surroundings of the position information from outside.

8. The information processing apparatus according to claim 7, wherein the image acquisition unit acquires an image captured by a vehicle that the user requests to join from the vehicle.

9. The information processing apparatus according to claim 7, wherein the image acquisition unit acquires a captured image captured by a camera installed around the position information from the camera.

10. The information processing apparatus according to claim 1, wherein in a case where the target is a person, the feature is at least one piece of information indicating a nearby object, clothes color, clothes type, bag color, bag type, whether the person is looking at a communication device, and whether the person is wearing a mask.

11. The information processing apparatus according to claim 1, wherein the feature is at least one piece of information of color of the target, type of the target, a character shown on the target, and a pattern shown on the target.

12. A mobile object comprising:
an image acquisition unit configured to acquire a captured image;
an extraction unit configured to detect a plurality of targets included in the captured image, and extract a plurality of features for each of the detected plurality of targets;
an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation unit configured to generate the question to reduce a number of questions for minimizing the impurity based on the features extracted by the extraction unit and the impurity for each of the features.

13. A control method of an information processing apparatus, the control method comprising:
an image acquisition step of acquiring a captured image;
an extraction step of detecting a plurality of targets included in the captured image, and extracting a plurality of features for each of the detected plurality of targets;
an impurity acquisition step of acquiring an impurity for each feature extracted in the extraction step, the impurity indicating a degree to which a predetermined target is inseparable from among the plurality of targets in a case where a user is asked a question for presuming the predetermined target from among the plurality of targets based on each feature; and
a generation step of generating the question to reduce a number of questions for minimizing the impurity based on the features extracted by the extraction unit and the impurity for each of the features.

14. A control method of a mobile object, the control method comprising:
an image acquisition step of acquiring a captured image;
an extraction step of detecting a plurality of targets included in the captured image, and extracting a plurality of features for each of the detected plurality of targets;
an impurity acquisition step of acquiring an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation step of generating the question to reduce a number of questions for minimizing the impurity based on the features extracted by the extraction unit and the impurity for each of the features.

15. A non-transitory storage medium storing a program for causing a computer to function as:
an image acquisition unit configured to acquire a captured image;
an extraction unit configured to detect a plurality of targets included in the captured image, and extract a plurality of features for each of the detected plurality of targets;
an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation unit configured to generate the question to reduce a number of questions for minimizing the impurity based on the features extracted by the extraction unit and the impurity for each of the features.

16. A non-transitory storage medium storing a program for causing a computer to function as:
an image acquisition unit configured to acquire a captured image;
an extraction unit configured to detect a plurality of targets included in the captured image, and extract a plurality of features for each of the detected plurality of targets;
an impurity acquisition unit configured to acquire an impurity for each feature extracted by the extraction unit, the impurity indicating a degree to which a predetermined target is inseparable from among the plurality of targets in a case where a user is asked a question for presuming the predetermined target from among the plurality of targets based on each feature; and
a generation unit configured to generate the question to reduce a number of questions for minimizing the impurity based on the features extracted by the extraction unit and the impurity for each of the features.
